(19) United States
(12) Patent Application Publication
(10) Pub. No.: US 2020/0351226 A1
(43) Pub. Date: Nov. 5, 2020

(54) METHOD FOR CREATING AN ALBUM BY AUTO POPULATING IN REAL TIME BY AN APPLICATION

(71) Applicant: Grace Lew, (US)

(72) Inventor: Grace Lew, Encino, CA (US)

(21) Appl. No.: 16/402,628

(22) Filed: May 3, 2019

(51) Int. Cl. H04L 12/58; H04L 29/08; G06T 11/60; G06F 16/906; G06F 3/0482

(52) U.S. Cl. CPC H04L 51/046; H04L 67/2804; G06F 3/0482; G06F 16/906; G06T 11/60

(57) ABSTRACT

The present application discloses a method for automatically creating an album by an application, comprising selecting the album and titling in the application; capturing at least one media, photo and or video via the application; texting for the at least one media in a journal bar while reviewing the at least one media at same time; and automatically, self-populating, in real time, directly into the album. All entries will have date, time and location stamped under each entry to ensure the accuracy. In addition, the present application allows the user to invite one or more additional contributor to the selected album. All contributor entries will self-populate in real time and chronologically alongside all entries made to the selected album. When the album is finalized, the album may automatically date, on the cover and spine of the album, alongside the title with the date of the first and last entry.

### TECHNICAL FIELD OF THE INVENTION

The present application generally relates to software applications, and more particularly, to a method for automatically creating an album by an application. Specifically, no more manual selecting and then uploading required like all other album creating applications. The present application may populate the selected album with photo, video and/or personalized text entries automatically and directly into selected album instantly as the user takes them.

### BACKGROUND OF THE INVENTION

Traditional methods of documenting personal or family history include compiling photo albums with printed photos, writing journals by hand, and taking home videos. However, these traditional methods are time consuming, expensive, and inconvenient.

Now with the wide-spread use and reliance of mobile devices such as a smartphone or tablet, it has become common for a user to capture and store photos, videos and text messages on such mobile devices. Several online or web-based programs or applications such as Shuttertly, Chatbook and Mossaic, have been developed which enable a user to create a digital photo album which can then be printed in hard copy. These programs allow the user to customize and create photo-based projects.

However, these programs have various drawbacks. The main drawback is that the album does not self-populate in real-time. The user must select images after the fact and then upload to a server or selected album.

Another drawback is that if the user wants to enter a text entry to journal a milestone, sentiment, comment or thought regarding than photo or video just took, the user must do that after the event when editing the album.

In addition, there is no application providing the capability of combining video to become a part of the digital album in real-time, chronologically alongside the photo and text entries. Specifically, no application allows the user to create a digital album with the combination of photo, text and video directly into the selected album instantly as the user takes photo, or video or text a journal entry instantly, in real-time, auto-populating, chronologically, time, date and/or location stamping each entry as it happens, creating the most well document and organized album/journal for life most precious moments.

The other drawback in other applications is the amount of time required by a user to create a photo album. The programs require the user to select the photographs to be included in a photo album. Upload to a server that groups photos by occasion or invitation. Text entries can be included but can only be done after the fact, but not in real-time alongside the photo captured and video recorded.

The current methods and systems for digitally preserving personal and familial history are deficient for several reasons. First, users find the process of sitting down even on the phone to sift through the user's inventory of digitally accumulated photos, into a digital album, time-consuming and inconvenient. Photos now-a-days tend to just remain on one's phone or external drive or the cloud, because most users are not wanting to spend the extra step to have to select and upload in order to create an album. Second, combining such albums with hand-written or inserting descriptive text in relation to each photo is also time-consuming and done after the fact. The thought an or sentiment has past and the user is less likely to make an entry after the fact because it is time consuming and the thought or sentiment no longer seems important or it has been forgotten. Indeed, many find the effort of tracking down and preserving such documentation too much of a hassle to bother with at all and in turn risk losing the memories associated with all of it forever stored randomly on hard drives, iCloud and other storage options. This creates a chaotic way to save all of lives most valuable memories and a challenging way to call them up when desired.

Thus, there is a need for a system, method, and apparatus to compile photos, journal, text entries, and home movies into a single, unified volume instantly, in real-time and chronologically directly into the selected album. This eliminates the extra step of having to select and then uploading images, videos and text to the album in order to create it.

There is a further need for a system and method to do so in real-time, as the photos and home movies are captured, and thoughts and events giving rise to the journal entries occur creating the most, accurately documented album, that saves directly down to the second created that entry. Each entry included time, date and/or location stamp under each entry in the album.

Moreover, there is a need for a system, method, and apparatus which regularly provides the user with one or more physical and digital copies of the created photo albums and journals, accompanied by a digital, and organized library within our application's server, done in real-time and chronologically so as to ensure life's most precious memories are saved and preserved in the most accurate precise way possible. Down to the day, time and place it had happened. Saved and stored in the most accurate way. A journal and preserving system that is the most accurate and organized.

### SUMMARY OF THE INVENTION

The present application discloses a method for automatically creating an album by an application to provide users a more convenient method for storing memorable moment.

The method for automatically creating an album by an application comprises selecting the album in the application; capturing at least one media via the application; texting for the at least one media in a journal bar; and automatically populating the at least one media directly into the album in real time.

According to an exemplary embodiment of the method, wherein the step of selecting the album in the application comprises creating the album. The step of creating the album comprises selecting an album template and titling the selected album.

According to the other exemplary embodiment, wherein the step of selecting the album in the application comprises selecting an existing album.

In various exemplary embodiments, wherein after the step of selecting the album in the application, the method further comprises ability of inviting one or more contributing member to contribute in real time alongside the creator of the album.

In various exemplary embodiments, wherein after capturing the at least one media via the application, the method further comprises showing the at least one media by the application. In addition, the step of text entry for the at least one media in the journal bar comprises reviewing the at least one media at same time.

In various exemplary embodiments, wherein the step of capturing the at least one media via the application comprises capturing a photo, taking a video or recording via the application.

According to the other exemplary embodiment, wherein the step of automatically populating the at least one media in the album comprises populating the at least one media chronologically. Each Entry will automatically include place, time and date under each entry to ensure the most accurate documentation.

In various exemplary embodiments, wherein after automatically populating the at least one media in the album, the method further comprises storing the album on a storage media. In addition, the step of storing the album on the storage media comprises automatically storing the album on a non-writable storage media, a writable storage media, or a communications media.

In various exemplary embodiments, wherein after the step of automatically populating the at least one media in the album, the method further comprises reminding when the at least one media reaches a minimum amount; ability of selecting at least one or more contributing member; and creating at least one physical copy of the album. Application will automatically include date of first entry and last entry of the selected album on the cover and the spine of the album alongside the title of the album. The step of creating at least one physical copy of the album, videos accompanying the selected album comprises creating VD or CD to store the Video Contributions to the actual physical Album. Digital version of the album will have all entries within the album, populating chronologically. The step of reminding when the at least one media reaches the minimum amount comprises reminding when the at least one media reaches 90 pages.

In various exemplary embodiments, wherein after the step of automatically populating the at least one media in the album, the method further comprises sending an alert when the album is full.

In various exemplary embodiments, wherein after the step of automatically populating the at least one media in the album, the method further comprises reviewing the album and making simple edits before purchasing.

Based on the above, the present application allows users to creating an album without the added step of having to select and upload to fill an album. In addition, the user may also invite other edit member to contribute media for the album at the same time.

In current technology, it is required for the user to leave the capturing function such as camera or recorder to input the words. Other applications do not allow user cannot write down the comments in real time, it is very likely to forget or lost the emotion or thought afterwards. However, in our application the journal bar is shown when reviewing the media after capturing, the user may record the memorable moment by texting words inside the journal bar in real time. The entry automatically popped out journal bar provides the users a more intuitive way to input their comments at the time.

Numerous other advantages and features of the present application will become readily apparent from the following detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIGS. 1A-C are a flow chart of a method for automatically creating an album by an application.

FIG. 2 is a view showing the application on a mobile device.

FIG. 3 is a view showing an interface of creating an account.

FIG. 4 is a view showing an interface of creating a new album or selecting from existing albums.

FIG. 5 is a view showing an interface of selecting an album template.

FIG. 6 is a view showing an interface of titling the album.

FIG. 7 is a view showing an interface of inviting at least one edit member to contribute.

FIGS. 8-9 are views showing an interface of capturing at least one media entry via the application.

FIG. 10 is a view showing an interface of texting for the at least one media in a journal bar.

FIGS. 11-12 are views showing an interface when the album is full.

FIG. 13 is a view showing an interface of editing the media.

FIG. 14 is a view showing an interface after editing the media.

FIGS. 15-16 are views showing an interface of creating at least one physical copy of the album.

FIGS. 17-19 are views showing an interface of sharing the album to the at least one sharing member.

FIG. 20 is a view showing a network configuration diagram.

### DETAILED DESCRIPTION OF DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

As used herein, the following terms and variations thereof have the meanings given below, unless a different meaning is clearly intended by the context in which such term is used.

The terms “a,” “an,” and “the” and similar referents used herein are to be construed to cover both the singular and the plural unless their usage in context indicates otherwise.

As used herein, the term “comprise” and variations of the term, such as “comprising” and “comprises,” are not intended to exclude other additives, components, integers or steps.

The terms “couple,” “coupled,” “couples,” and “coupling,” refer to connecting two or more elements or signals electrically, mechanically, or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent, semi-permanent, or only for an instant.

“Image” or “photo” refers to a digital or print image.

The terms “photo album,” “digital album,” “photo book,” or “scrapbook” means any type of media-based project, in digital or print form. A photo album may be printed on paper and bound together as a book.

“Media files” refers to audio files, video files, text files, or image files.

Embodiments of the present application relate to applications, methods, and systems for creating media-based projects, such as a photo album.

The present application is directed to a program or application that is run on a mobile device. The application is concerned with creating a digital volume containing a compilation or album with photos, a journal, and home videos as well as providing the photo album and journal in the form of a bound, physical album with an accompanying digital copy of the home videos and photos contained in the album.

The photos can be taken by one or more users and stored within the memory of each user's electronic device and on the application's server.

The personal text of the journal can be input directly by the user, or meta data may be automatically populated by the use from the photo's meta-data, which includes time, date and location.

The home videos may together comprise a video log, video diary, or other short film or video taken to record and preserve experiences, activities, and special events as it happens and is stored, chronologically, in real-time alongside photo and text entries.

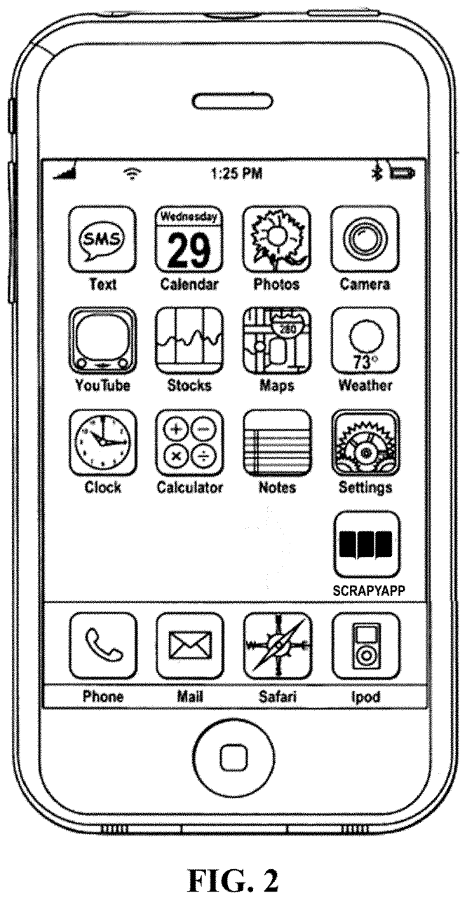

The program or application of the present application can be used in connection with an electronic device. The electronic device may be mobile device such as a tablet computer, mobile computer or smartphone but may also be embodied in any one of a wide variety of wired and/or wireless computing devices. For example, FIG. 2 depicts the use of the program or application with a smartphone. The electronic device includes a processing device (processor), input/output interfaces, a display, a network interface, a memory, an operating system, and storage. The electronic device may also include a touchscreen interface for ease of use, and a global positioning system (GPS) communicating across a local data bus.

The electronic device incorporates a system containing the program or application for creating ae

The processing device may include any custom-made or commercially available processor, a central processing unit (CPU), or an auxiliary processor among several processor associated with the electronic device, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory can include any one of a combination of volatile memory elements (e.g., random-access memory (RAM, such as DRAM, and SRAM, etc.)) and nonvolatile memory elements. The memory typically comprises native operating system, one or more native applications, emulation systems, or emulated applications for any of a variety of operating systems and/or emulated hardware platforms, emulated operating systems, etc.

The present application may include application specific software, which may comprise some or all the components of the electronic device. In accordance with such embodiments, the components are stored in memory and executed by the processing device. The system and method for digital scrapbooking may be resident in the memory of the electronic device.

In one aspect of the present application, the touchscreen interface is configured to detect contact within the display area of the display, and provides such functionality as on-screen buttons, menus, keyboards, etc. that allows a user to navigate user interfaces by touch. More particularly, user interfaces navigable by touch may be configured to allow users to access digital photo albums.

In another aspect of the present application, the electronic device has a Global Positioning System (GPS) or other means to determine the geographical location of the electronic device. This may allow the user or the application to efficiently determine the time and location that particular events were captured. This information may be automatically incorporated into the visible body of the scrapbook page.

One of ordinary skill in the art will appreciate that the memory can, and typically will, comprise other components that have been omitted for purposes of brevity. In the context of this disclosure, a non-transitory computer-readable medium stores one or more programs for use by or in connection with an instruction execution system, apparatus, or device.

An electronic device network interface may comprise various components used to transmit and/or receive data over a networked environment. When such components are embodied as an application, the one or more components may be stored on a non-transitory computer-readable medium and executed by the processing device.

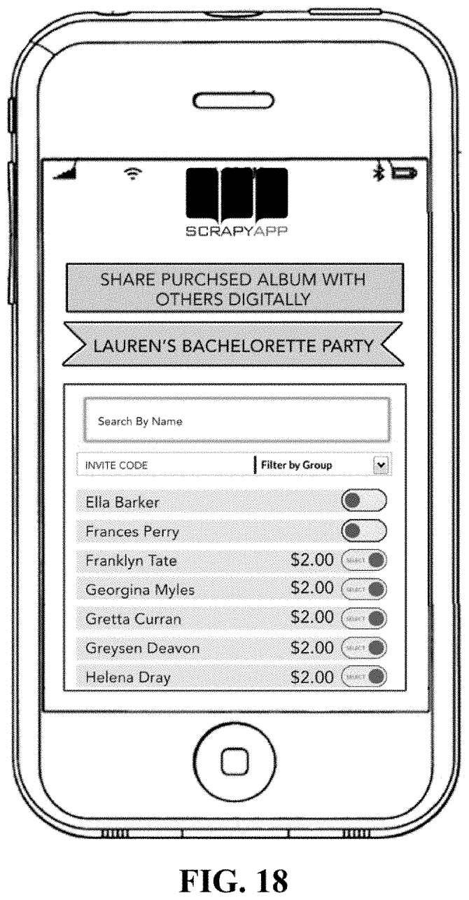

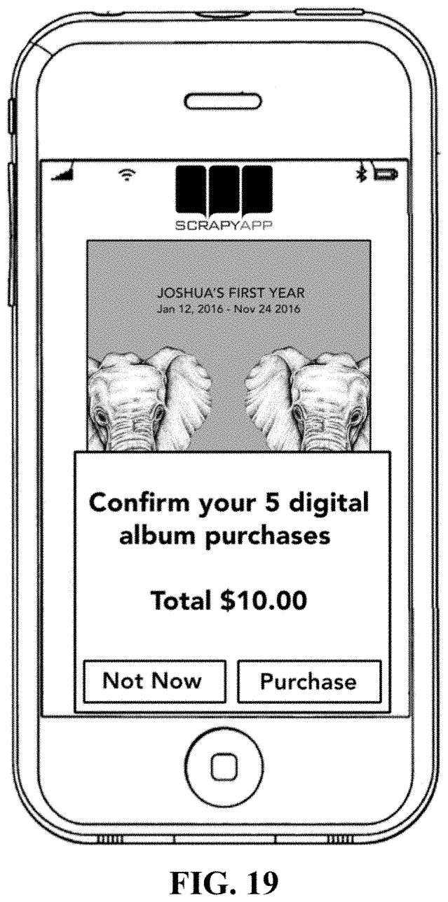

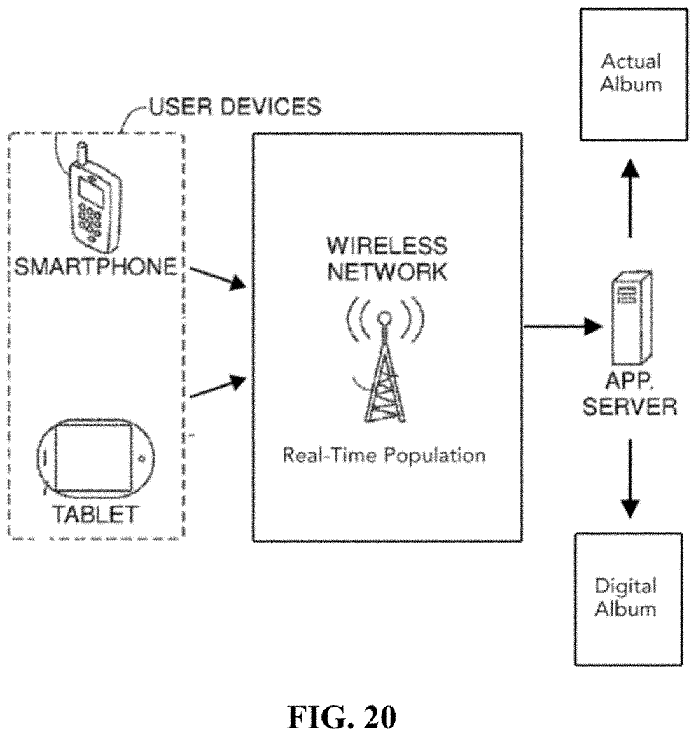

In one aspect, the present application comprises the networked environment of the system and method for digital scrapbooking. For example, multiple electronic devices may be communicatively coupled via a communication network, as shown in FIG. 20. By way of example and not limitation, each of the electronic devices may be embodied as a mobile computing device such as, for example and without limitation, a smartphone, as illustrated in FIGS. 2-19, or a tablet computer that incorporates cellular telephone functionality. The communications network can use one or more of various communications types such as, for example and without limitation, cellular and Wi-Fi communications.

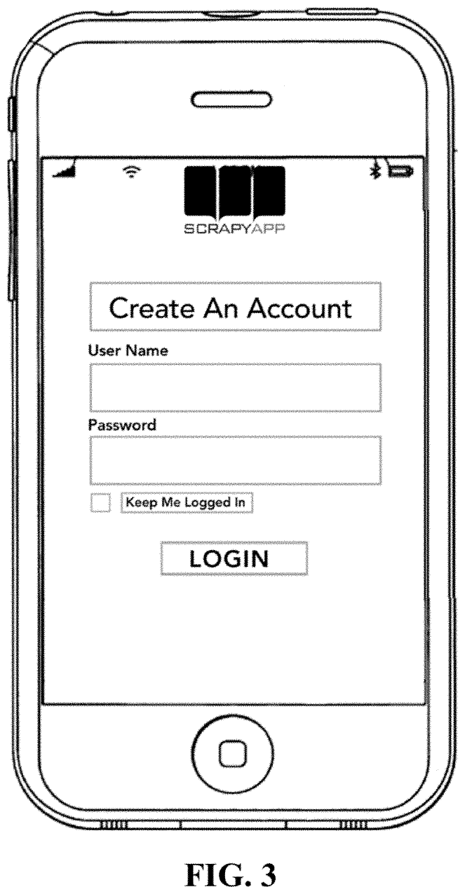

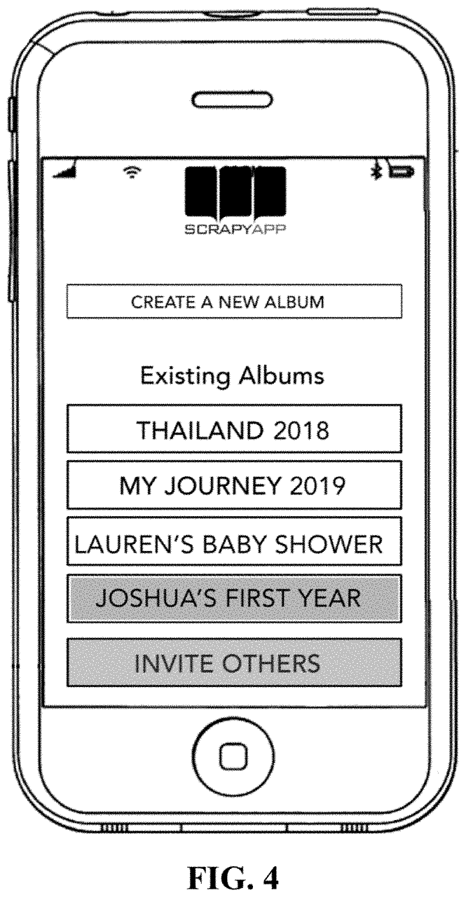

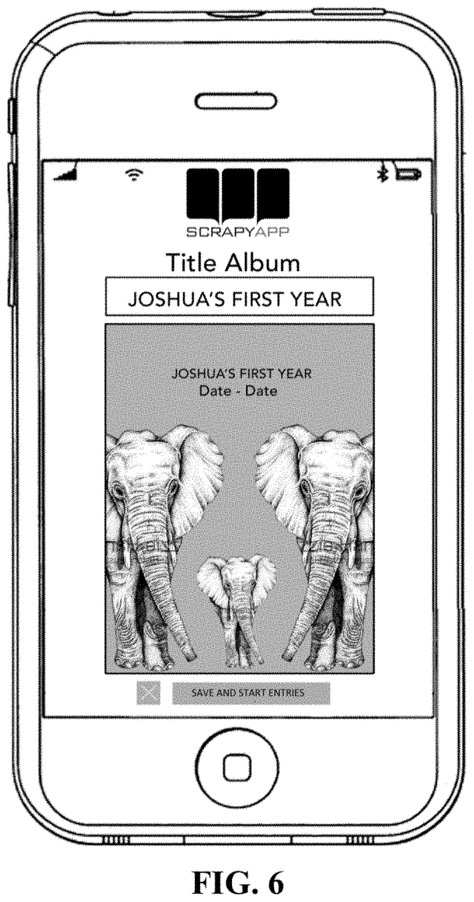

The first step a user will engage in is creating an account, as shown in FIG. 3. Next, the user will create a photo album as shown in FIG. 6 or select from existing albums as shown in FIG. 4. The user will also have the ability to invite other users to access the photo album, as shown in FIG. 4.

It is contemplated that the application of the present application may instruct the electronic device to access a digital photo album. The digital photo album may be stored on the electronic device such as in an image galley or library typically stored in a memory portion of exemplary electronic devices.

In one aspect of the present application, the time, date and location information related to a particular photo, video or text entry, may be stored in any digital metadata associated with the photo, and the device automatically incorporate this information into the journal entry relating to the photo. In other words, the system may be configured to automatically include text that indicates where and when a photo, video, and/or journal entry was made on each digital photo album page.

In another embodiment, the user may be prompted to manually type or otherwise indicate the particular context of each selected photo, for example, whether the photo relates to a milestone or accomplishment, a humorous happenstance, or any other description a user deems appropriate.

One aspect of the present application is implemented as a program, application, or product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present application, are embodiments of the present application. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present application, are embodiments of the present application. Broadly, computer-readable storage media and communications media may be referred to herein as computer-readable media.

If embodied in software, each step in the method of making a digital scrapbook or album may comprise program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as any of the aforementioned electronic devices. The machine code may be converted from the source code, etc. If embodied in hardware, each step of the exemplary methods may represent a circuit or a number of interconnected circuits to implement the specified logical function(s). Additionally, although the steps of the exemplary methods are discussed in specific orders of execution, it is to be understood that the orders of execution may differ.

The application of the present application may instruct the electronic device to access a digital video library comprising one or more home videos, video diaries, or other videos that may be stored in a memory portion of the electronic device. Any videos chosen from such a video library may be related in time, subject, location, or context to the aforementioned photos and journal entries and may also be accompanied by journal entries as described above.

In general, the routines executed to implement the embodiments of the present application may be part of an operating system or a specific application, component, program, module, object, or sequence of instructions. The computer program of the present application typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the present application. However, it should be appreciated that any particular program nomenclature that follows is used merely for convenience, and thus the present application should not be limited to use solely in any specific application identified and/or implied by such nomenclature.

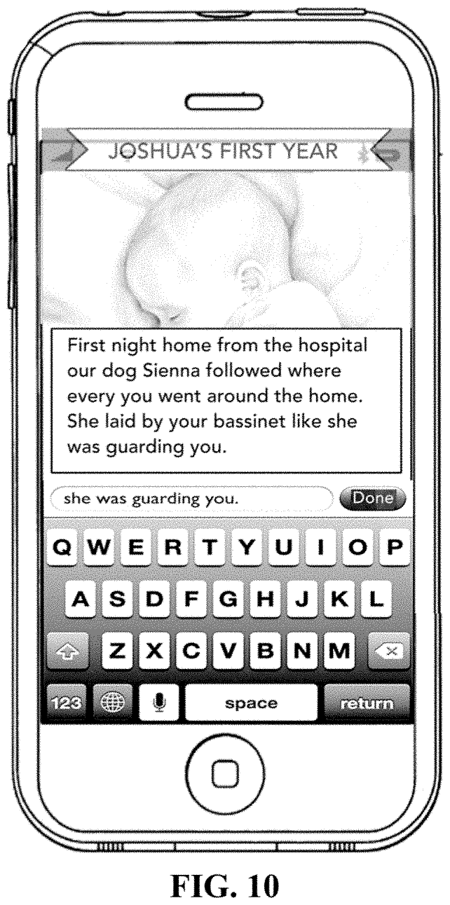

The contemplated that digital album of the present application combines aspects of a photo album, journal, and various home videos may be created chronologically so that all, or a variety of user can contribute, photos and videos and text entries to go directly into the album. The electronic device may also receive instructions to configure the one or more photos accompanied by corresponding journal entries on one or more album pages. In one embodiment, a template optionally containing a theme may be provided to accommodate a preset number of photos and/or a preset number of album pages and journal entries, as shown in FIG. 10. In another embodiment, the template may place the photos in a predetermined configuration on each of the album pages. In yet another embodiment, a template may be provided to accommodate journal entries. It is also contemplated that the electronic device automatically populates album page templates with photos and journal entries including information from the metadata of each photo. Use of the metadata of the photo is advantageous because the user may not remember where or when the photo was taken.

It is further contemplated that the number of scrapbook pages, and length of any detailed descriptions may be uniquely specified by the user.

The application of the present application allows the user to efficiently preserve the user's personal or family history as events occur in a digitally created scrapbook. This digitally created scrapbook provides viewers a more accurate sense of the history surrounding the subjects of the combined photos, journals, and home videos. Moreover, it may relieve the user of the difficulty associated with compiling photos and videos, as well as drafting captions to describe the photos and videos.

It is also contemplated that the application may receive instructions to create multiple photo albums simultaneously. For example, if a parent would like to create a photo album for each of his or her two or more children, he or she may create a separate album, designated by a title of his or her choosing, for each child. Then, the user may direct photos, videos, and journal entries relating to each child to the child's respective album simultaneously as the user captures moments that he or she would like to preserve in the child's respective album. In addition to sorting by a person, it is contemplated that the application may be instructed to store and contribute to multiple scrapbooks so that a user may create scrapbooks featuring certain events, people, stories, themes or any other reason they may wish to separate their photos, videos, and journal entries.

In one aspect of the present application, the application may store each photo album for a user to return to or complete at a later date. This may allow a user to include events in a scrapbook as they occur without any fear that prior pages or memories will be lost or otherwise inaccessible.

The aforementioned steps may be repeated until various photos, journal entries, application does not provide embellishments surrounding the photos and journal entries are presented in a series of digital pages. Such pages may also be accompanied by digitally captured home videos so that the user may be provided with a unified digital copy of related photos, journal entries, and videos.

It is an additional object of the present application to include journal entries included in the digitally created scrapbook. It is still another object of the present application to provide printed copies of any digitally created scrapbooks to one or more third parties specified or selected by a user.

Also presented is a system comprising the application of the present application, an electronic device, a network, one or more servers, and a service provider. The service provider can be, for example, a commercial company that is in the business of printing books. The service provider may be instructed to provide a physical copy of the digital photo album with journal entries once a predetermined number of digital pages have been designed. For example, the system may be instructed to print a fifteen-page album. Thus, when photos, journal entries, and video encompass fifteen printed pages, the system is instructed to print the digitally rendered pages and deliver them in the form of a bound, printed volume to the creator of the book. One skilled in the art will recognize that videos are not generally printed in still, frame-by-frame form as photos are. It is contemplated that any home videos accompanying the photos and journal entries in the album may be included with the printed volume in digital form. In this digital album form, to be shared via the internet, videos will appear chronologically, alongside photo and text entries. For example, a CD ROM, DVD, or thumb drive may be appended to the volume containing such home videos. In one embodiment, a digital copy, such as stored on a DVD, secure digital (SD) card, or thumb drive, of the digital photo album pages and journal entries may also be appended to the printed volume. It is also contemplated that, individual photos included in the printed volume may be included in digital form.

It is also contemplated that the system may be instructed to print and send a physical and digital copy of the combined photo album, journal and home videos after a specified amount of time has passed. For example, the system may be instructed to compile and send album pages and home videos at the end of a single month, every three months, or even every year. Of course, such prescribed time periods are offered only by way of example and not of limitation.

The system may also allow the user to share the combination photo album, journal, and home videos with friends, family members, and others. For example, the system may be instructed to send a printed volume, along with a digital copy of any home videos and copy of the album, of the digitally created album to any address associated with the friends, family, or others.

It is contemplated that the system may communicatively link the user with family, friends, and others in a social network embodied by the system and method for digital scrapbooking. Optionally, the digitally created photo album, journal, and compiled home videos may be shared on existing social networking websites such as Facebook® and Twitter®.

The server is made up of hardware and software to implement the instructions of the application as directed by a client. The client can on a mobile device or tablet. In the present application, a server implements the system and method for digital scrapbooking and facilitates sending digital and physical copies of any completed albums to the user and any members of the network associated with the completed scrapbooks. In order to facilitate the aforementioned functionality, various aspects may be performed by one or more of the aforementioned electronic devices. In one aspect, the electronic device is operative to perform, at least in part, an embodiment of the method for digital scrapbooking. This method may include, for example: accessing a digital photo album; selecting one or more photos from the photo album; receiving detailed descriptions comprising journal entries associated with each of the one or more selected photos; applying the one or more selected photos with their corresponding journal entries in a chosen configuration on a digital page; applying one or more design specifications as embellishments on the digital page; selecting home videos to include; repeating the prior steps until a variety of embellished photos and journal entries as well as home videos are presented on a predetermined number of digital pages; and delivering a printed volume including the photos and journal entries to one or more specified recipients with a digital copy, such as on a CD ROM, of the compiled home videos, digital album pages and/or individual photos included in the printed volume.

The present application also contemplates operation of a system that is operative to perform for a method of performing digital scrapbooking. This method automatically populates your photos, videos and text entries. Printing the digital pages; and delivering a printed volume including the photos and journal entries to one or more specified recipients with a digital copy, such as on a CD ROM containing the home videos, digital album pages and/or individual photos included in the printed volume. And a Digital Album that can be purchased and shared on the internet with Videos included within the digital album.

It is also contemplated that users of the application of the present application may create their own private social network centered on a particular combination of photos, journal entries and home videos. For example, in one aspect of the present application, an album that memorializes a celebratory gathering, such as a wedding, baby showers, anniversaries and themed parties, might include each of the guests of the wedding as part of the social network to contribute to selected albumin real-time. As another example, the album may depict images and events associated with a newborn's first months, and the social network may comprise the newborn's close relatives and friends of the newborn's parents. Indeed, the social network may comprise any such family members, friends, or others who may be particularly concerned with preserving memories reflected in a scrapbook.

Once an album is completed, the user who created it may instruct the system to send a digital or print copy of the album of photos, videos and journal entries to anyone in your social network.

In another aspect of the present application, the digital or print copies of a completed scrapbook may be sent to a family member, friend, or others independent of his or her membership in the social network. For example, a user may instruct the system to send digital or print copies of the album to one or more family members, friends, or other associates by uploading an address to the system.

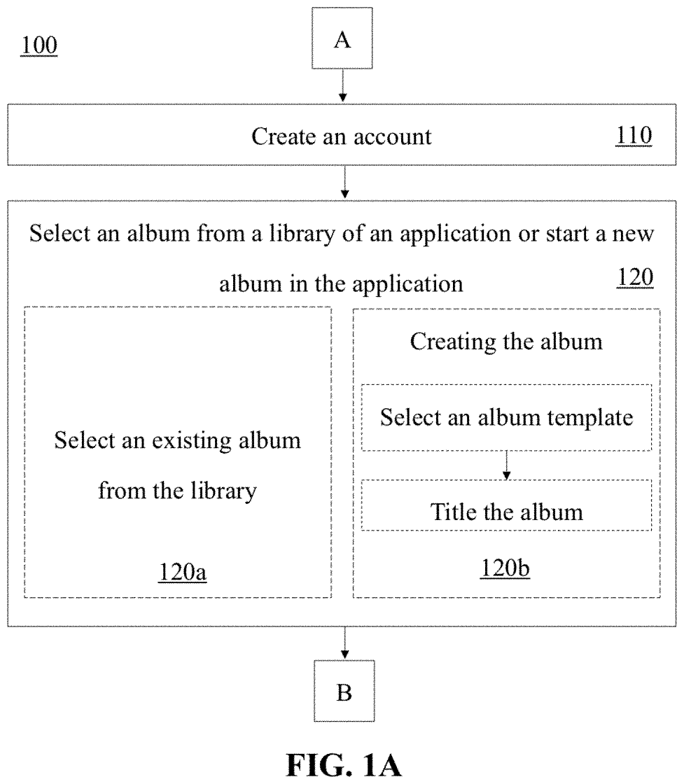

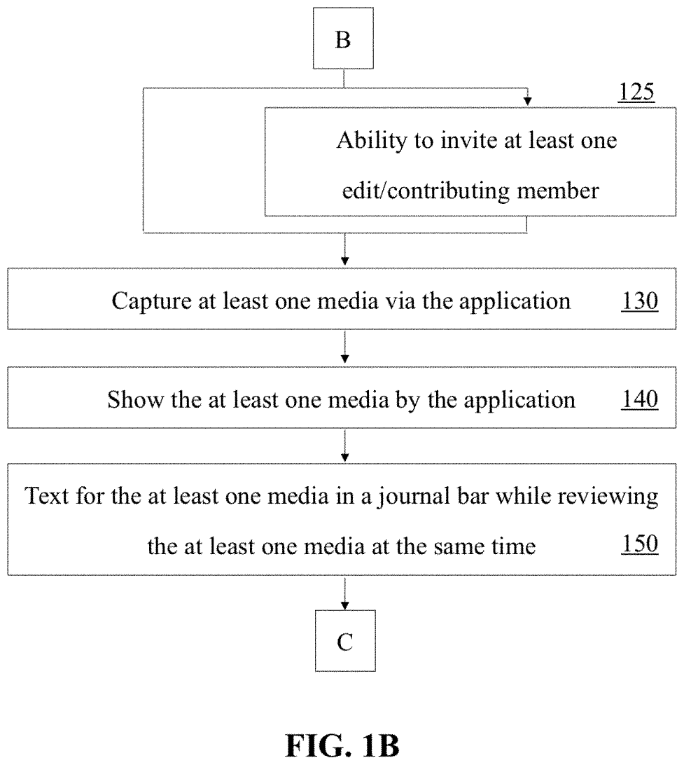

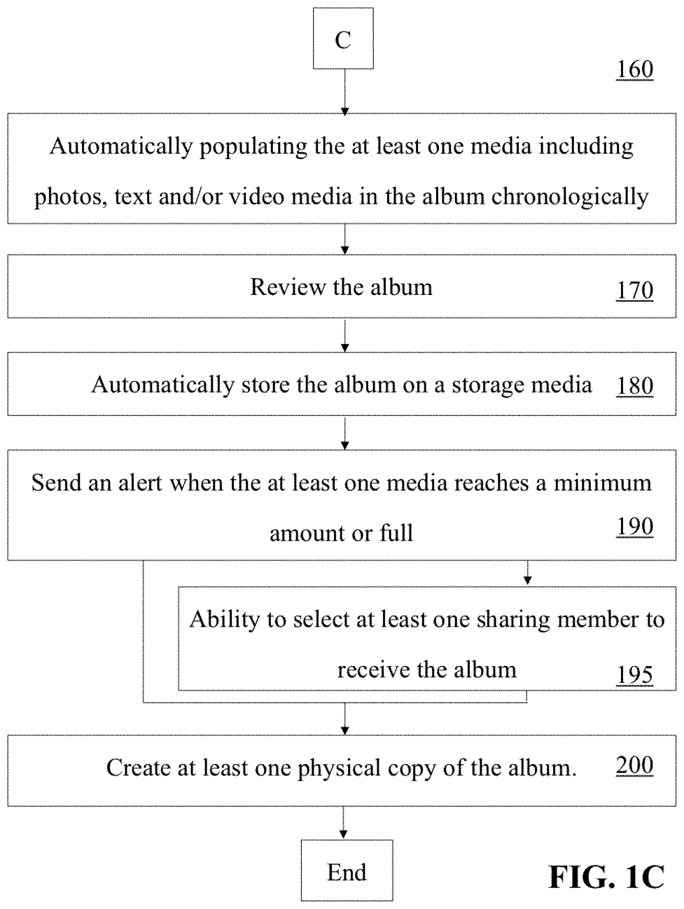

Referring to FIGS. 1A-IC with reference of FIGS. 2-20 to further describe an example of the method 100 for automatically creating an album by an application of the present application.

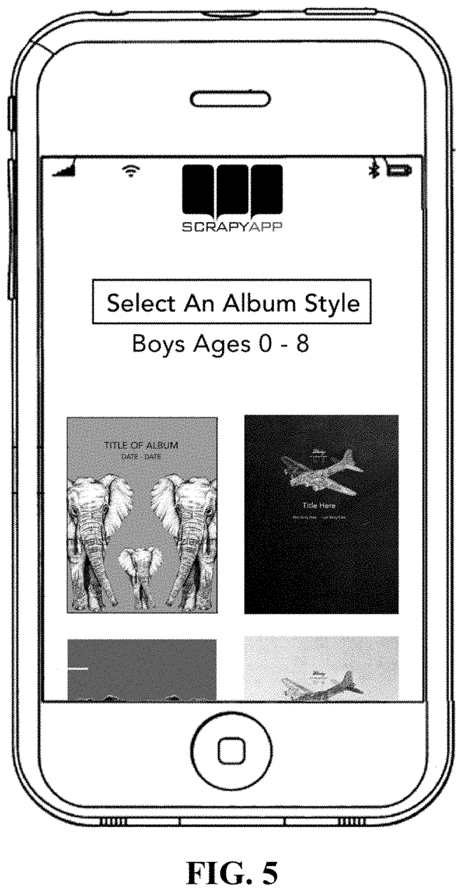

First, selecting the application and creating an account as shown in step 110 and FIGS. 2-3. Next, selecting an album in the application as shown in step 120. Specifically, the user may select an existing album created and stored in album library as shown in step 120a and bottom portion of FIG. 4. Or, the user may create a new album as shown in step 120b and top portion of FIG. 4. Specifically, in step 120b, the user may select an album template as shown in FIG. 5 and title the album as shown in FIG. 6.

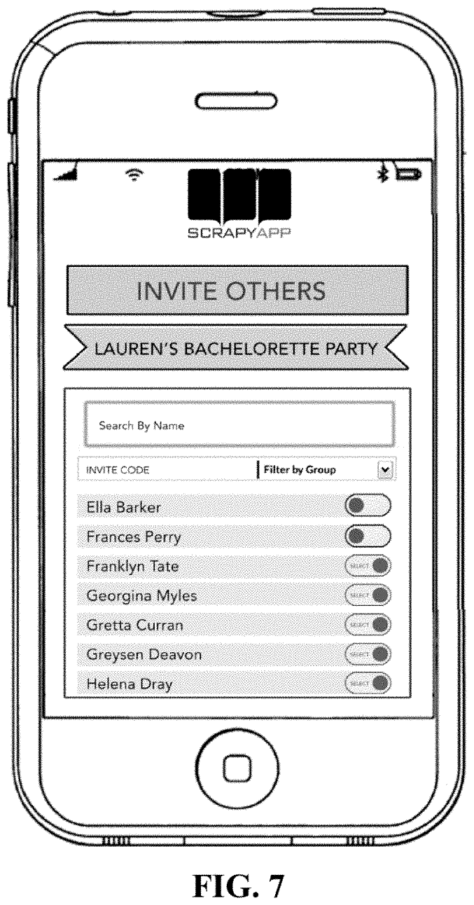

After selecting the album in the application as step 120, the user may start to capture the media or invite at least one edit member to contribute media for the album together as shown in step 125 and FIG. 7. Specifically, the present application allows the user to select edit members from contact list. As such, the edit members may contribute alongside while the user updating the album.

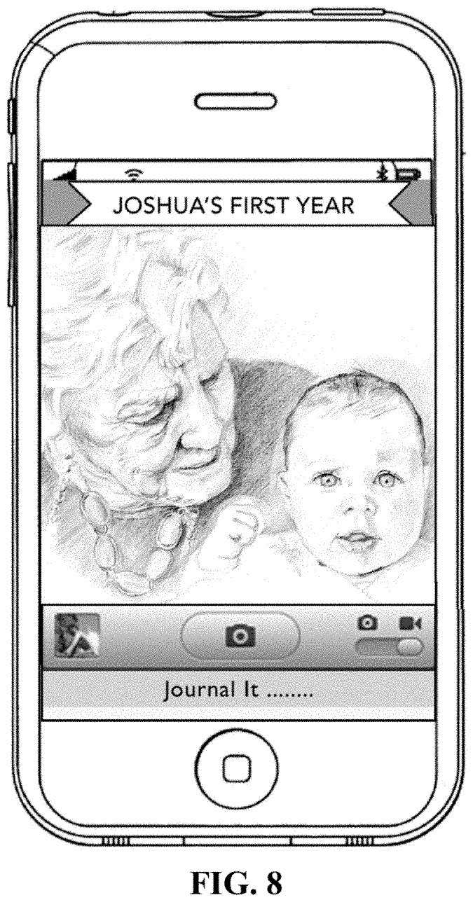

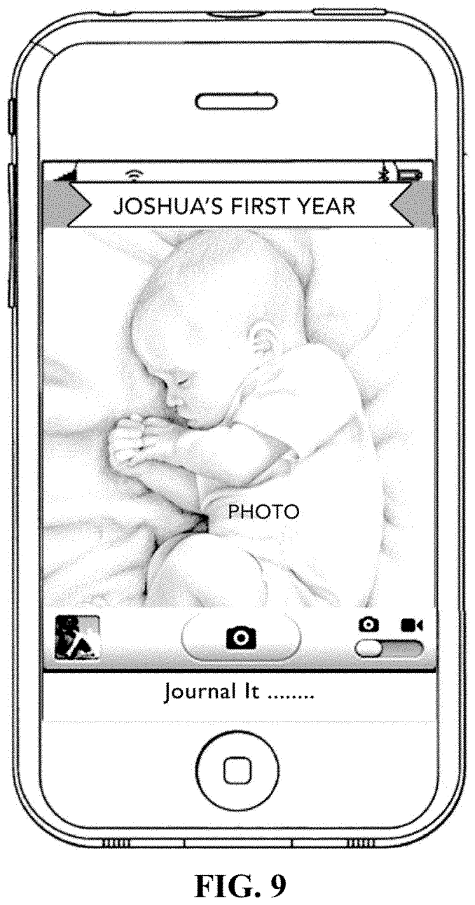

As shown in step 130, the at least one media is captured via the application. In detail, if the user did invite other edit member in step 125, a plurality of sub-albums is created according to location of other edit member as shown in step 135. As such, multiple contributors can contribute the media into the album and share it afterwards. In step 130, the user can select taking video function as shown in FIG. 8 or picturing function as shown in FIG. 9.

Ater capturing, the application may show the captured media as shown in step 140. In the meantime, the user may text for the captured media in a journal bar while reviewing the captured media as shown in step 150 and FIG. 10. Specifically, the user may not leave the captured function such as camera and text for the captured media. As such, the user does not need to leave the camera function to type the comments. Therefore, the current feeling can be recorded immediately, and will not be forgotten due to record lately. The journal bar shown immediately with the captured media provides an intuitive choice for the user to record every moment.

After texting for the captured media, the application may automatically populate the captured media in the album chronologically and in real time as shown in step 160. The user may select the arrangement method; the present application is not limited thereto. In detail, the captured media with the text/journal entry will be saved into selected album alongside together with time, date and location stamp under each entry.

Next, as shown in step 170, the user can review the album. After confirmation of the user, the album will be stored on a storage media as shown in step 180.

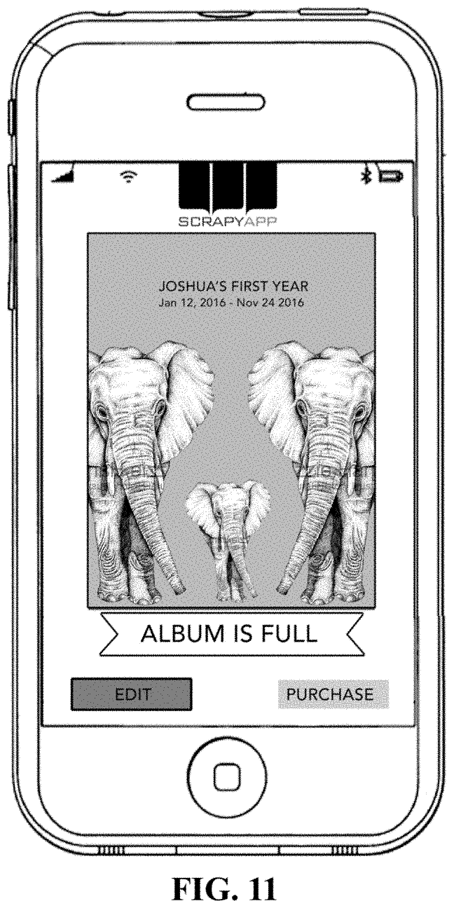

Referring to FIG. 11 and step 190, the system may send an alert the user when the media reaches a minimum amount or full. Specifically, the minimum amount of the present application is 90 pages. Each page may comprise different amount of media, depending on user setting.

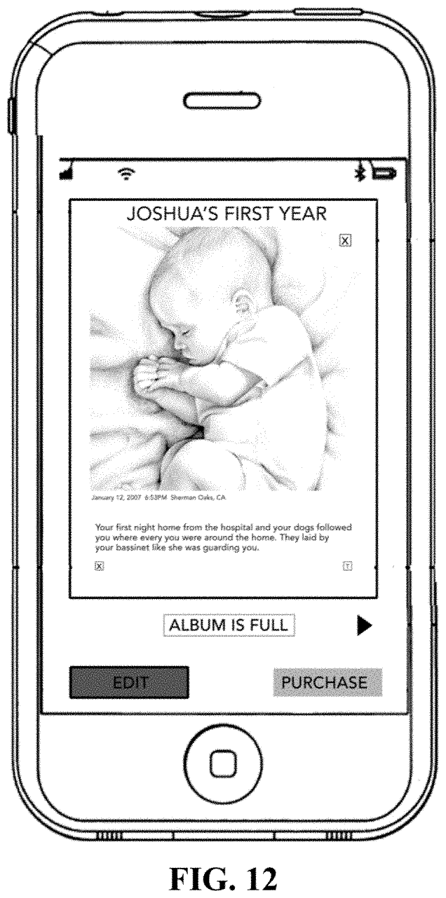

When reaches the minimum amount, the user may keep input the media, review pages, edit or create a physical copy. Specifically, as shown in FIG. 12, if the user would like to edit the media after reviewing, the top portion is editable for the title of the album. The “X” at the right upper corner means remove the media. The “X” at left lower corner means remove text entry. The “T” at the right lower corner means edit text entry. The “button” above purchase button means going forward to the next page.

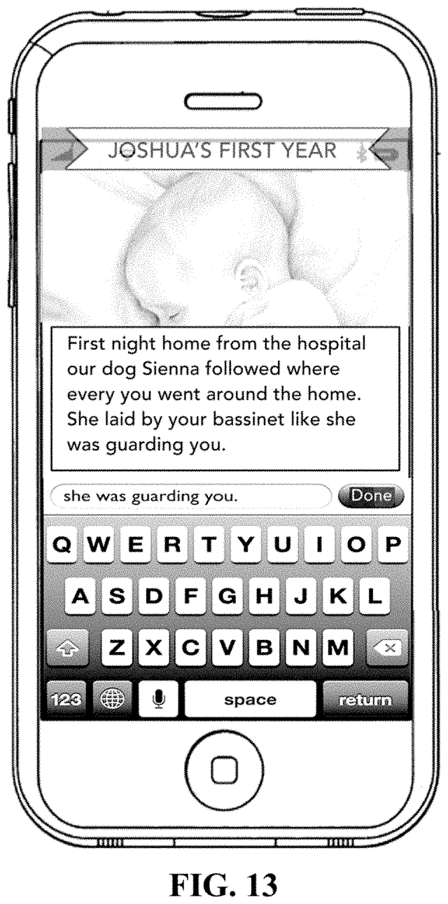

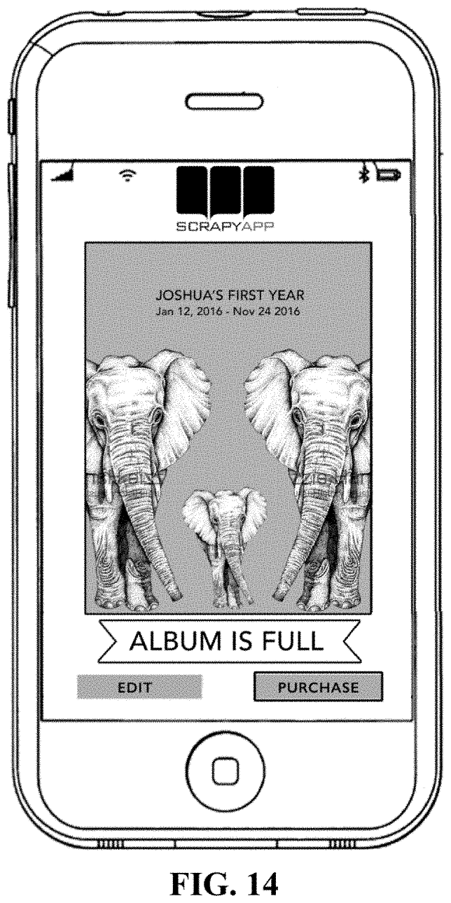

For example, if the user clicks the “T” button, the journal bar will be appeared again for editing as shown in FIG. 13. After finishing editing, the interface will jump back to the cover as shown in FIG. 14.

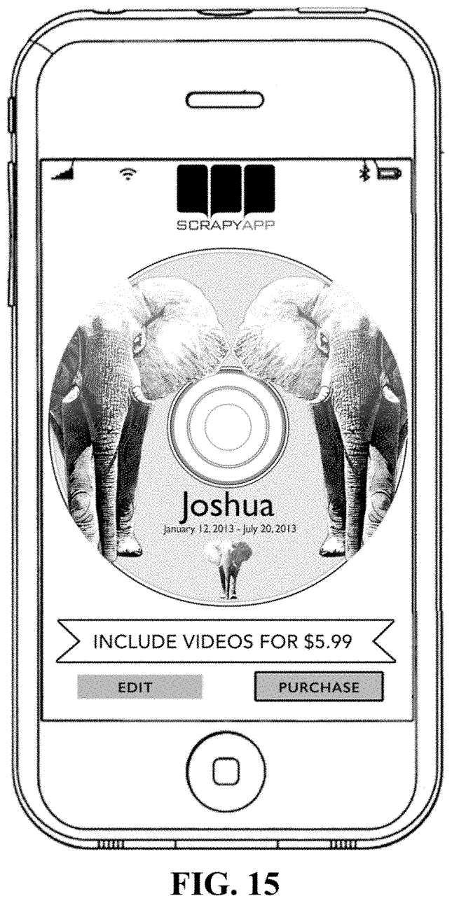

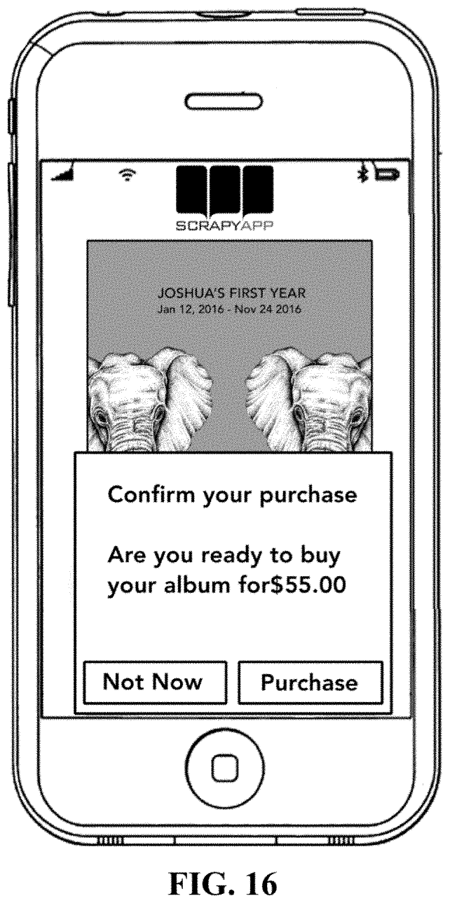

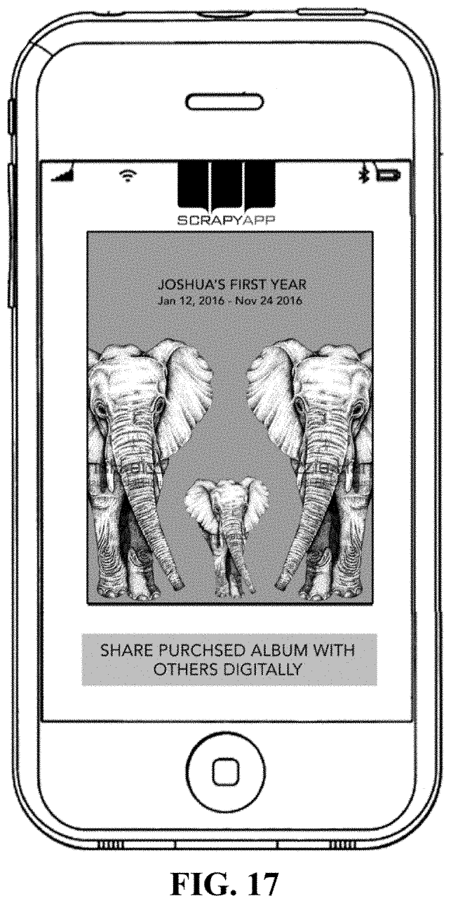

If the user would like to create a physical copy, the user may click the purchase button as shown in FIGS. 15-16. In addition, the user may select sharing member(s) to share as shown in step 195 and FIGS. 17-19.

Lastly, as shown in step 200, at least one physical copy of the album is created. The application will automatically add date of the first entry to the last entry to the cover and the spine of the album alongside the title of album. The physical copy may be a DVD or CD; the present application is not limited. The DVD or CD can be stored in aback sleeve on the back of the album.

Based on the above, the present application allows users to creating an album without manually uploading every figures. In addition, the user may also invite other edit member to contribute media for the album, or contributing and creating multiple sub-albums at the same time.

In current technology, it is required for the user to leave the capturing function such as camera or recorder to input the words. Other applications do not allow user to write down the comments in real time, it is very likely to forget or lost the emotion or thought afterwards. However, the journal bar of the present application is shown when reviewing the media after capturing, the user may record the memorable moment by texting words inside the journal bar in real time. The entry automatically popped out journal bar provides the users a more intuitive way to input their comments at the time. In conclusion, the present application provides a method for creating an album in real time that automatically self-populates photo, video and/or personalized text entries immediately as the photo, video and/or text entry is made.

It will be apparent to those skilled in the art that various modifications and variations can be made to the structure of the present application without departing from the scope or spirit of the present application. In view of the foregoing, it is intended that the present application cover modifications and variations of this application provided they fall within the scope of the following claims and their equivalents.

1. A method for automatically creating an album by an application, comprising:
selecting the album in the application;
capturing at least one media via the application with a journal bar shown at a screen;
showing the at least one media by the application;
texting for the at least one media in the journal bar while reviewing the at least one media at same time; and
automatically populating the at least one media chronologically directly into the album in real time.

2. The method for automatically creating the album by the application as claimed in claim 1, wherein the step of selecting the album in the application comprises creating the album.

3. The method for automatically creating the album by the application as claimed in claim 2, wherein the step of creating the album comprises selecting an album template.

4. The method for automatically creating the album by the application as claimed in claim 2, wherein the step of creating the album comprises titling the album.

5. The method for automatically creating the album by the application as claimed in claim 1, wherein the step of selecting the album in the application comprises selecting an existing album in a library.

6. The method for automatically creating the album by the application as claimed in claim 1, wherein after the step of selecting the album in the application, the method further comprises inviting at least one edit member from a mobile contact list.

7. (canceled)

8. The method for automatically creating the album by the application as claimed in claim 1, wherein the step of capturing the at least one media via the application comprises capturing a photo, taking a video or recording via the application.

9. (canceled)

10. The method for automatically creating the album by the application as claimed in claim 1, wherein after automatically populating the at least one media in the album, the method further comprises storing the album on a storage media.

11. (canceled)

12. The method for automatically creating the album by the application as claimed in claim 1, wherein after the step of automatically populating the at least one media in the album, the method further comprises sending an alert when the at least one media reaches a minimum amount.

13. The method for automatically creating the album by the application as claimed in claim 12, wherein after the step of sending the alert when the at least one media reaches the minimum amount, the method further comprises creating at least one physical copy of the album.

14. The method for automatically creating the album by the application as claimed in claim 13, wherein before the step of creating at least one physical copy of the album, the method further comprises selecting at least one sharing member.

15. The method for automatically creating the album by the application as claimed in claim 13, wherein the step of creating at least one physical copy of the album comprises creating a digital album.

16. The method for automatically creating the album by the application as claimed in claim 12, wherein the step of sending the alert when the at least one media reaches the minimum amount comprises sending the alert when the at least one media reaches 90 pages.

17. The method for automatically creating the album by the application as claimed in claim 1, wherein after the step of automatically populating the at least one media in the album, the method further comprises sending an alert when the album is full.

18. The method for automatically creating the album by the application as, claimed in claim 1, wherein after the step of automatically populating the at least one media in the album, the method further comprises reviewing the album.
